(19) United States
(12) Patent Application Publication
(10) Pub. No.: US 2009/0175670 A1
(43) Pub. Date: Jul. 9, 2009

(54) Label roll rack of barcode printer

(76) Inventor: Ching-Wen Chen, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/318,713

(22) Filed: Jan. 7, 2009

(30) Foreign Application Priority Data
Jan. 7, 2008 (TW) 097200326

(51) Int. Cl. B41J 15/00

(52) U.S. Cl. 400/613

(57) ABSTRACT

A label roll rack is provided for a barcode printer and includes a shaft rod and at least one retention bar. The shaft rod has an end coupled to a housing of the barcode printer to receive a label roll to fit thereon, serving as a support axle for the label roll. The shaft rod forms on surfaces thereof sliding slots extending in a horizontal axial direction. The retention bar has a lower end forming opposite coupling sections each having an inside surface forming a projection, which is fit in the respective sliding slot of the shaft rod to make the retention bar substantially normal to and realizing a retention condition with respect to the shaft rod, wherein the retention bar is movable in the horizontal axial direction for positioning and retaining label rolls of various sizes fit on the shaft rod. The retention bar, when moved to a free end of the shaft rod, is rotatable, with the free end of the shaft rod serving as pivoting center, with respect to the shaft rod to a horizontal axial direction to be coaxial with the shaft rod for easing mounting and dismounting of the label roll onto/from the shaft rod.

### BACKGROUND OF THE INVENTION

1. Field of the Invention

The present invention relates to a label roll rack of a barcode printer, and in particular to a label roll rack that is applicable to a barcode printer for accommodating fitting thereon and removing therefrom label rolls of different sizes so as to ease mounting/dismounting of label rolls.

2. The Related Arts

A conventional barcode printer is commonly used in various applications where printing of barcode label stickers is needed. The barcode printer requires a label roll mounted therein to continuously supply barcode label stickers for printing thereon desired barcodes by the barcode printer. The conventional barcode printer is provided with a label roll axle, which can only mount label rolls of a specific size and does not includes means for properly positioning the label roll. Thus, additional positioning accessory must be provided on other parts of the barcode printer to help positioning the label roll. This makes installation and manufacturing of the label roll axle complicated and expensive; and in addition, the conventional label roll axle cannot accommodate labels of different sizes. All these are certainly adverse to the development of the industry.

### SUMMARY OF THE INVENTION

Thus, in view of the above discussed problems, the present invention is aimed to provide a label roll rack for a barcode printer in order to solve the above problems associated with mounting/dismounting and positioning of label rolls in the barcode printer.

An objective of the present invention is to provide a label roll rack of a barcode printer, which comprises a label roll retention bar that is movable in a horizontal axial direction to accommodate mounting and positioning of label rolls of various sizes on the label roll rack.

Another objective of the present invention is to provide a label roll rack of a barcode printer, which comprises a shaft rod for receiving a label roll to fit thereon and a retention bar that is substantially perpendicular to the shaft rod for positioning and retaining the label roll and wherein the retention bar is rotatable with respect to the shaft rod to be substantially coaxial with the shaft rod for easing mounting and dismounting of the label roll to/from the shaft rod.

To achieve the above objective, the present invention provides a label roll rack for a barcode printer, comprising a shaft rod and at least one retention bar. The shaft rod has an end coupled to a housing of the barcode printer to receive a label roll to fit thereon, serving as a support axle for the label roll. The shaft rod forms on surfaces thereof sliding slots extending in a horizontal axial direction. The retention bar has a lower end forming opposite coupling sections each having an inside surface forming a projection, which is fit in the respective sliding slot of the shaft rod to make the retention bar substantially normal to and realizing a retention condition with respect to the shaft rod, wherein the retention bar is movable in the horizontal axial direction for positioning and retaining label rolls of various sizes fit on the shaft rod. The retention bar, when moved to a free end of the shaft rod, is rotatable, with the free end of the shaft rod serving as pivoting center, with respect to the shaft rod to a horizontal axial direction to be coaxial with the shaft rod for easing mounting and dismounting of the label roll onto/from the shaft rod. Thus, the objectives of easy mounting/dismounting label rolls of various sizes onto/from and properly positioning of the label rolls can be realized.

### BRIEF DESCRIPTION OF THE DRAWINGS

The present invention will be apparent to those skilled in the art by reading the following description of a preferred embodiment thereof, with reference to the attached drawings, wherein:

FIG. 1 is a perspective view of a label roll rack constructed in accordance with the present invention for a barcode printer;

FIG. 2 is an exploded view of the label roll rack in accordance with the present invention;

FIG. 3 is a perspective view illustrating the label roll rack of the present invention mounted in a barcode printer;

FIG. 4 is a side elevation of the label roll rack mounted in the barcode printer to illustrate the operation thereof; and

FIG. 5 is a front elevation of the barcode printer to illustrate the label roll rack of the present invention positioning and retaining a label roll thereon.

### DETAILED DESCRIPTION OF THE PREFERRED EMBODIMENT

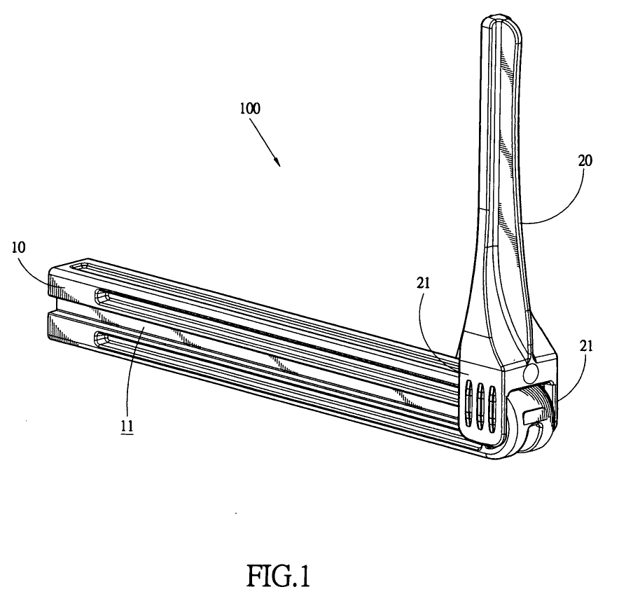

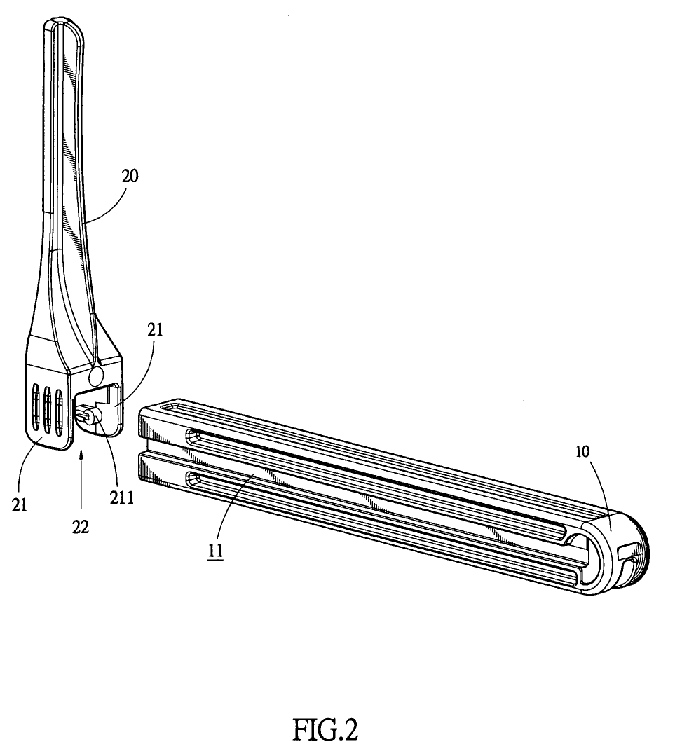

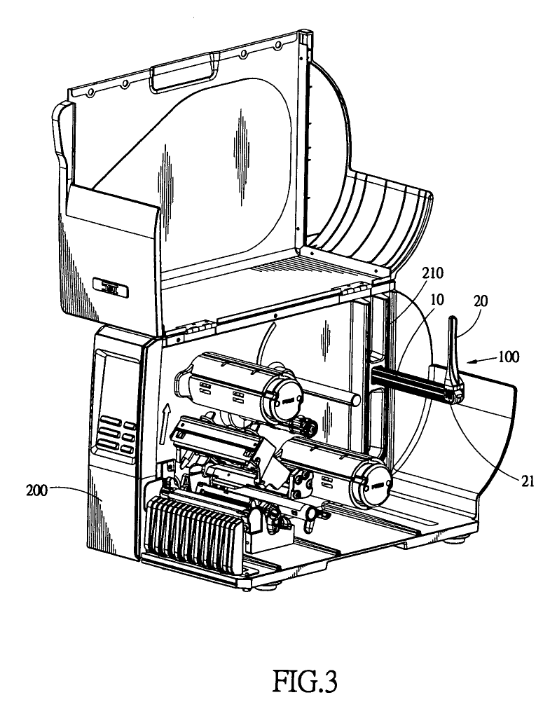

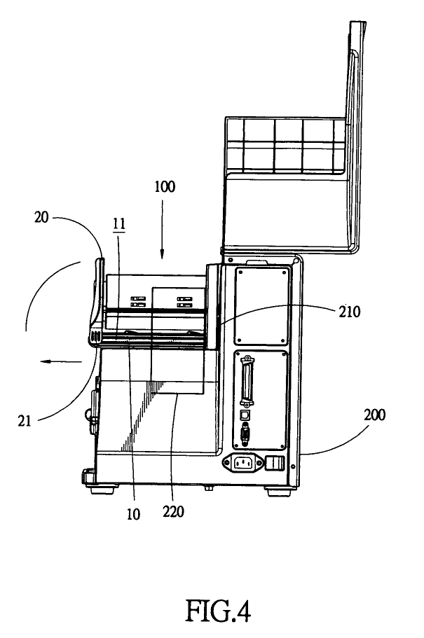

With reference to the drawings and in particular to FIGS. 1-3, a label roll rack constructed in accordance with the present invention, generally designated at 100, is provided for a barcode printer 200 (FIG. 4). The label roll rack 100 comprises a shaft rod 10 having an end attached to a housing 210 of the barcode printer 200, as shown in FIG. 4, in such a way that the shaft rod 10 is coupled to the housing 210 in an axial and horizontal arrangement. The shaft rod 10 forms in surfaces thereof opposite sliding slots 11 along an axial horizontal direction. The shaft rod 10 functions to receive a label roll 220 which supplies blank labels to the barcode printer 200 to fit thereon.

At least one retention bar 20 has a lower end forming opposite coupling sections 21, which are spaced from each other to form a gap 22 therebetween. Each coupling section 21 has an inside surface forming a projection 211. With the projections 211 slidably received in the respective sliding slots 11 formed on the surfaces of the shaft rod 10, the coupling sections 21 mount the retention bar 20 to the shaft rod 10 in such a way that the retention bar 20 is substantially normal to the sliding slots 11 of the shaft rod 10 and the retention bar 20 is slidable horizontally along the axis of the shaft rod 10 and thus the slots 11 to selectively and properly retain/position the label roll 220 on the shaft rod 10.

When the retention bar 20 is moved to a free end of the shaft rod 10, in which a cross-section-enlarged cavity (not labeled) is formed and communicating each sliding slot 11, the projections 211 of the retention bar 20 may serve as pivot axis about which the retention bar 20 is rotatable. This, together with the gap 22 formed between the coupling sections 21 that is sized and configured to accommodate the end of the shaft rod 10, allows the retention bar 20 to rotate with respect to the shaft rod 10 so that the retention bar 20 may be oriented horizontally as the horizontal axial position of the shaft rod 10. In this way, the label roll 220 is allowed to fit over or detach from the shaft rod 10.

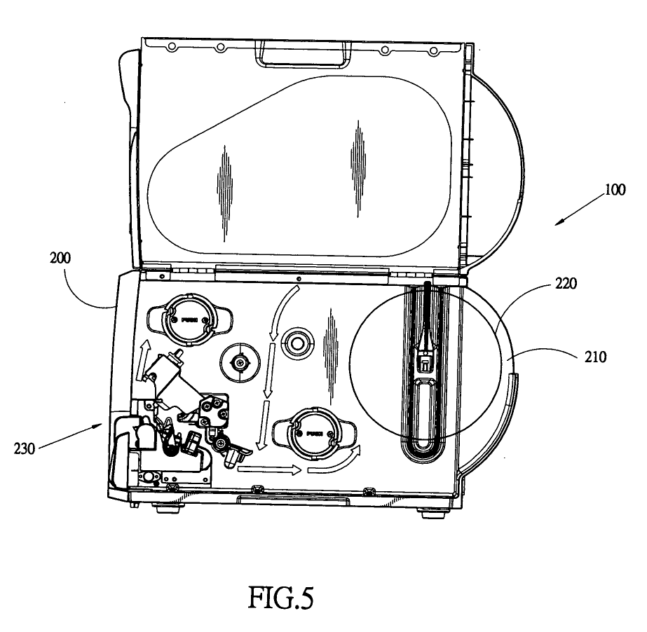

Also referring to FIGS. 4 and 5, the operation of the label roll rack 100 in the barcode printer 200 in accordance with the present invention with will be described. By means of a range of horizontal movement/displacement of the retention bar 20 with respect to the shaft rod 10, as indicated by the arrow of FIG. 4, the label roll 220 fit on the shaft rod 10 can be properly positioned and retained and such a retention bar 20 can accommodate retention and positioning for label rolls of different specifications (or widths). In other words, the retention bar 20, which is perpendicularly erected on the shaft rod 10, is horizontally movable along the axis of the shaft rod 10 to secure the label roll 220 that is interposed between the retention bar 20 and the housing 210 of the barcode printer 200, as shown in FIG. 5, in order to subject blank labels supplied from the label roll 220 to printing operation carried out by a printing mechanism 230 of the barcode printer 200.

When the label roll 220 that is mounted to the shaft rod 10 runs out of blank labels, or when there is a need to replace a different label roll, the retention bar 20 is horizontally moved along the axis of the shaft rod 10 to the free end of the shaft rod 10 and the retention bar 20 is then rotated to be horizontally oriented as indicated by curved arrow of FIG. 4 and substantially parallel to and preferably coaxial with the shaft rod 10, by which the label roll 200 can be removed from and re-mounted to the shaft rod 10. With the label roll 220 removed from the shaft rod 10 and replaced by a new one, the retention bar 20 is rotated back to the perpendicularly erected condition with respect to the shaft rod 10 and once again moved horizontally along the shaft rod 10 to position and retain the new label roll 220 on the shaft rod 10. In this way, the label rolls can be easily mounted to and removed from, as well as being positioned and retained on, the shaft rod 10.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A label roll rack for a barcode printer, comprising:
a shaft rod having an end adapted to couple to a housing of the barcode printer, the shaft rod being adapted to receive a label roll to fit thereon, the shaft rod forming on surfaces thereof sliding slots extending in a horizontal axial direction; and
at least one retention bar having a lower end forming opposite coupling sections respectively in movable engagement with the sliding slots so that the retention bar is movable in the horizontal axial direction along the shaft rod to position and retain the label roil on the shaft rod between the retention bar and the housing of the barcode printer.

2. The label roll rack as claimed in claim 1, wherein the shaft rod is coupled to the housing of the barcode printer in the axial horizontal direction.

3. The label roll rack as claimed in claim 1, wherein the coupling sections of the retention bar are set in engagement with the sliding slots of the shaft rod to have the retention bar substantially normal to the sliding slots of the shaft rod.

4. The label roll rack as claimed in claim 1, wherein the coupling sections of the retention bar forms at least one projection.

5. The label roll rack as claimed in claim 1, wherein the coupling sections of the retention bar form therebetween a gap.
